(19) United States
(12) Patent Application Publication
(10) Pub. No.: US 2025/0130468 A1
(43) Pub. Date: Apr. 24, 2025

(54) VR LUMINANCE-OPTIMIZED LCD DESIGN SEEN THROUGH THE LENS

(71) Applicant: Meta Platforms Technologies, LLC, Menlo Park, CA (US)

(72) Inventors: Hojin JEONG, Daejeon (KR); Rungrot KITSOMBOONLOHA, Los Gatos, CA (US); Hsin-Ying CHIU, San Jose, CA (US); Cagdas VAREL, Seattle, WA (US); Jun JIANG, Woodinville, WA (US); Sascha HALLSTEIN, Saratoga, CA (US)

(21) Appl. No.: 18/919,344

(22) Filed: Oct. 17, 2024

Related U.S. Application Data
(60) Provisional application No. 63/592,770, filed on Oct. 24, 2023.

(51) Int. Cl. G02F 1/1362; G02F 1/1343; H04N 13/344; H04N 13/383

(52) U.S. Cl. CPC G02F 1/136209; H04N 13/344; G02F 1/134309; H04N 13/383

(57) ABSTRACT

A near-eye display includes a display panel configured to display images, and display optics configured to project the images to a user's eye. A peak luminance angle at each region of a plurality of regions of the display panel matches a viewing angle of the region seen through the display optics. In one example, the display panel includes a liquid crystal display LCD) panel, and the peak luminance angle at each region is matched to the viewing angle of the region seen through the display optics by shifting black matrix elements with respect to light shield structures at the region of the LCD panel.

### CROSS-REFERENCE TO RELATED APPLICATION

This application claims the benefit of and priority to U.S. Provisional Application No. 63/592,770, filed Oct. 24, 2023, entitled “VR LUMINANCE-OPTIMIZED LCD DESIGN SEEN THROUGH THE LENS,” which is hereby incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10 to 20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through) or viewing displayed images of the surrounding environment captured by a camera (often referred to as video see-through).

A near-eye display may include an optical system configured to form an image of a computer-generated image on an image plane. The optical system of the near-eye display may relay the image generated by an image source (e.g., a display panel) to create a virtual image that appears to be away from the image source and further than just a few centimeters away from the user's eyes. For example, the optical system may collimate the light from the image source or otherwise convert spatial information of the displayed virtual objects into angular information to create a virtual image that may appear to be far away. The optical system may also magnify the image source to make the image appear larger than the actual size of the image source. It is generally desirable that the near-eye display has a small size, a low weight, a large field of view, a large eye box, a high efficiency, a high image quality, and a low cost.

### SUMMARY

This disclosure relates generally to near-eye displays or head-mounted displays. More specifically, and without limitation, techniques disclosed herein relate to reducing the brightness nonuniformity and/or brightness roll-off (BRO) of a near-eye display. Various inventive embodiments are described herein, including devices, systems, methods, structures, materials, processes, methods, and the like.

According to certain embodiments, a near-eye display may include a display panel configured to display images, and display optics configured to project the images to a user's eye. A peak luminance angle at each region of a plurality of regions of the display panel may match a chief ray angle (or viewing angle) of the region seen through the display optics. In some embodiments, the display panel may include a liquid crystal display (LCD) panel that includes a black matrix on a first substrate and light shield structures formed on a second substrate, and black matrix elements at each region of the plurality of regions may be shifted with respect to corresponding light shield structures at the region by a different respective amount such that the peak luminance angle at the region matches the chief ray angle (or viewing angle) of the region seen through the display optics. The amount of shift may gradually increase from a center region of the display panel to peripheral regions of the display panel in a horizontal direction, a vertical direction, both the horizontal direction and the vertical direction, or a radial direction. In some embodiments, the LCD panel may include thin-film transistor circuits formed on the second substrate, and the light shield structures may include gate electrodes, source electrodes, top light shields, bottom light shields, or a combination thereof.

According to certain embodiments, a display panel may include a first assembly including a first substrate and light shield structures formed on the first substrate, a second assembly including a second substrate and black matrix elements formed on the second substrate, and a liquid crystal layer between the first assembly and the second assembly. Black matrix elements at a center region of the display panel align with corresponding light shield structures on the first substrate. Black matrix elements at peripheral regions of the display panel are offset with respect to corresponding light shield structures on the first substrate. An amount of offset of the black matrix elements with respect to the light shield structures may gradually increase from the center region of the display panel to the peripheral regions of the display panel.

According to certain embodiments, a method of improving brightness uniformity of a near-eye display may include, for each region of a plurality of regions of a liquid crystal display (LCD) panel of the near-eye display, determining a chief ray angle of the region seen through display optics of the near-eye display, determining an offset between black matrix elements on a first substrate of the LCD panel and light shield structures on a second substrate of the LCD panel at the region for achieving peak luminance at the chief ray angle of the region, and shifting the black matrix elements with respect to the light shield structures at the region by the determined offset.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an optical system with a non-pupil forming configuration for a near-eye display device according to certain embodiments.

FIG. 6 illustrates an example of an image source assembly in a near-eye system according to certain embodiments.

FIG. 7 illustrates an example of a liquid crystal display (LCD).

FIGS. 8A and 8B include cross-sectional views of an example of an LCD panel.

FIG. 8C is a top view of the example of the LCD panel of FIGS. 8A and 8B.

FIG. 9 illustrates an example of a mismatch between the display peak emission angle of an LCD panel of a near-eye display and the chief-ray angles of the near-eye display for some regions of the LCD panel.

FIG. 10A illustrates an example of a near-eye display that includes a display panel and display optics.

FIG. 10B illustrates an example of a relationship between the display luminance and the field of view of the near-eye display of FIG. 10A.

FIG. 10C illustrates an example of display luminance variation across the field of view of an example of a near-eye display.

FIG. 11A illustrates an example of a display panel of a near-eye display.

FIGS. 11B-11D illustrate examples of the maximum transmittance angles at different regions of the near-eye display of FIG. 11A having different misalignments between thin-film transistors and color filters.

FIG. 12 illustrates an example of display brightness variation in the example of the display panel of the near-eye display of FIGS. 11A-11D.

FIGS. 13A-13C show different offsets between thin-film transistors and color filters in an LCD-based near-eye display.

FIGS. 13D-13F show examples of display luminance variation for different regions of the LCD-based near-eye display having different offsets between the thin-film transistors and color filters.

FIG. 14 illustrates an example of an LCD panel with a variable shift between thin-film transistors and color filters according to certain embodiments.

FIG. 15 illustrates an example of the variable shift between the thin-film transistors and the color filters of an LCD panel according to certain embodiments.

FIGS. 16A-16F illustrate examples of improving display luminance uniformity using an LCD panel with a variable shift between thin-film transistors and color filters according to certain embodiments.

FIG. 17 includes a flowchart illustrating an example of a method of reducing brightness nonuniformity of a near-eye display according to certain embodiments.

FIG. 18 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye displays or head-mounted displays. More specifically, and without limitation, techniques disclosed herein relate to reducing the brightness nonuniformity and/or brightness roll-off (BRO) of a near-eye display. Various inventive embodiments are described herein, including devices, systems, methods, structures, materials, processes, methods, and the like.

Display panels are generally designed to have uniform brightness properties, where the light beam emitted by each region of the display panel may have a certain (e.g., Gaussian) angular beam intensity profile with the peak luminance direction perpendicular to the display panel. However, the user's viewing angles and the chief ray angles for different regions or different fields of view (FOVs) of the display panel may vary across the display panel. For example, the chief ray for the center region of an LCD panel may be in the surface-normal direction of the LCD panel, but the chief ray for other regions of the LCD panel may be tilted at different angles with respect to the surface-normal direction of the LCD panel. In addition, display optics (e.g., a pancake lens or another lens) may, by its design, collect light within different angular ranges from different regions of the LCD panel and have different optical efficiencies for light of different incident angles, and thus may introduce brightness drop at larger FOV angles even with a perfectly uniform display. The mismatch between the display peak luminance angle and the chief ray angle (CRA) may lead to brightness variations, which may also vary with the user's gaze direction. Thus, as a user views the display screen through the display optics in a near-eye display, the perceived brightness may vary according to the user's viewing angles for different regions of the display panel. Brightness Roll-Off (BRO) effect generally refers to the phenomenon of perceived brightness changes or brightness non-uniformity across the field of view (FOV) of a near-eye display (e.g., VR, AR, or MR) device, which may result in a perceived FOV narrower than the target FOV. In LCD-based near-eye displays, the variation of the perceived luminance at different viewing angles may also be affected by the alignment between the thin-film transistor (TFT) glass and the color filter glass.

According to certain embodiments disclosed herein, an LCD panel may be designed to have peak luminance at the corresponding viewing angle (e.g., chief ray angle) of each region of the display panel seen through display optics (e.g., a lens such as a pancake lens) of a near-eye display. For example, the viewing angle of each region of a plurality of regions of the display panel seen though the display optics may be determined based on the configuration of the near-eye display. The offset between the color filters and the TFT circuits at each region of the plurality of regions to achieve peak luminance at the corresponding viewing angle may then be determined based on the desired peak luminance angle (which matches the viewing angle or chief ray angle) at the region. The color filters at each region may then be shifted with respect to the TFT circuits based on the determined offset to achieve peak luminance at the corresponding viewing angle through the display optics. In this way, the BRO effect or other brightness variations in the field of view can be reduced, even if there are some misalignment errors between the TFT glass and the color filter glass.

In some examples, a near-eye display may include a display panel configured to display images, and display optics configured to project the images to a user's eye. A peak luminance angle at each region of a plurality of regions of the display panel may match a viewing angle (e.g., chief ray angle) of the region seen through the display optics. In some embodiments, the display panel may include a liquid crystal display (LCD) panel that includes a black matrix on a first substrate (e.g., a color filter glass substrate) and light shield structures in drive circuits formed on a second substrate (e.g., a thin-film transistor glass substrate), where black matrix elements at each region of the plurality of regions may be shifted with respect to corresponding light shield structures at the region by a different respective offset (e.g., >0, =0, or <0) such that the peak luminance angle at the region matches the viewing angle of the region seen through the display optics. The offset may gradually increase from a center region of the display panel to peripheral regions of the display panel in a horizontal direction, a vertical direction, both the horizontal direction and the vertical direction, or a radial direction. In some embodiments, the drive circuits may include thin-film transistor circuits, and the light shield structures on the second substrate may include gate electrodes, source electrodes, top light shields, bottom light shields, or a combination thereof.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

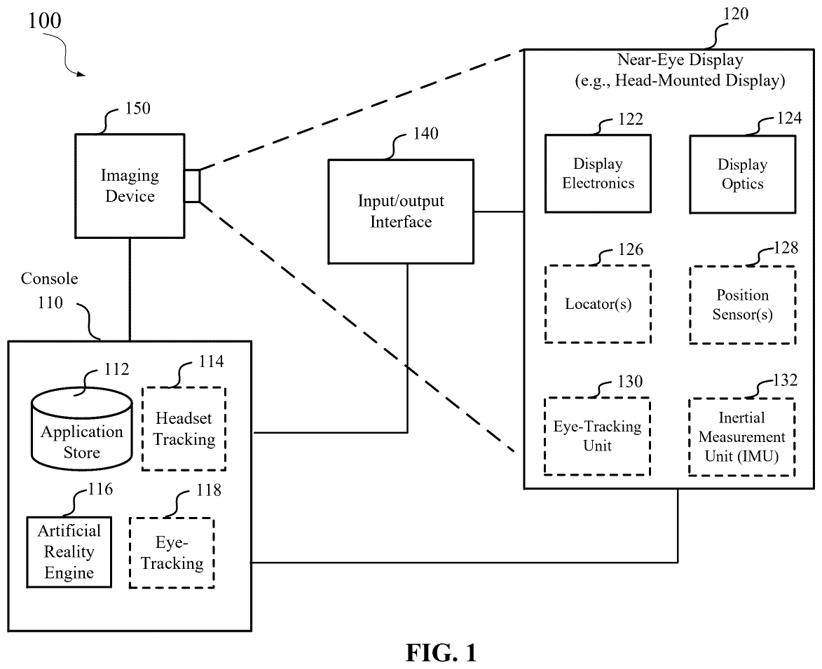

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

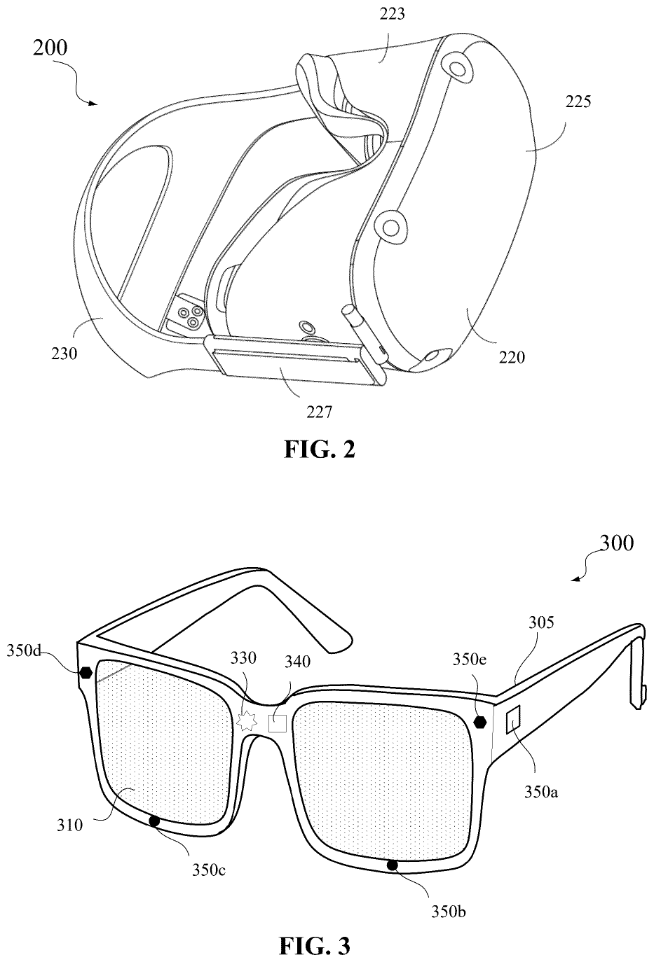

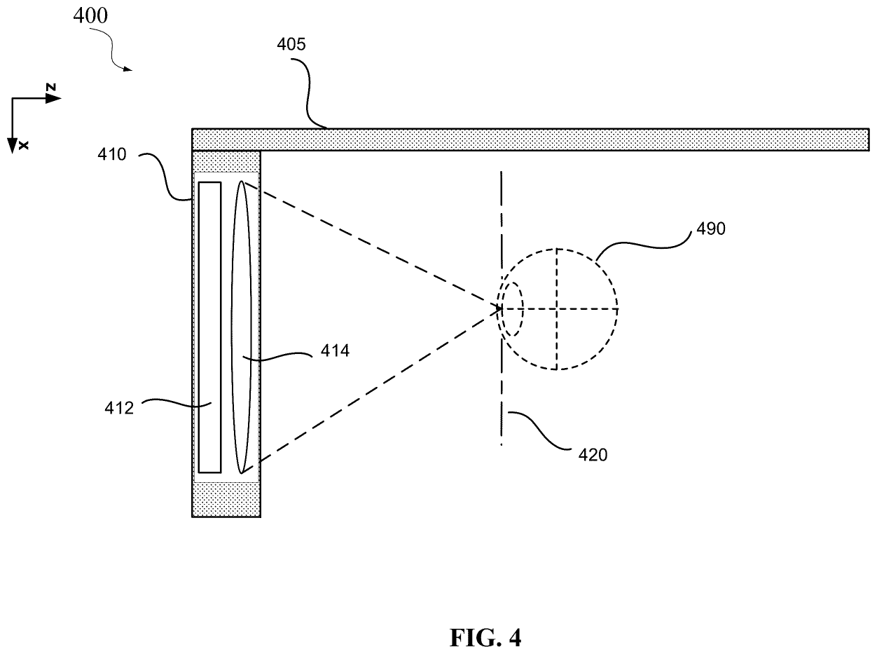

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to function as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a uLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350c on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

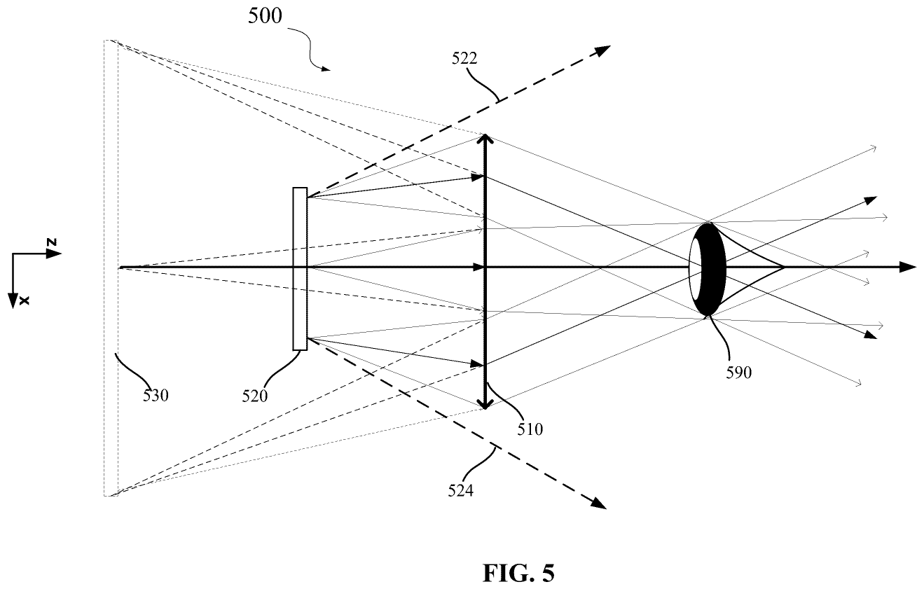

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 40, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

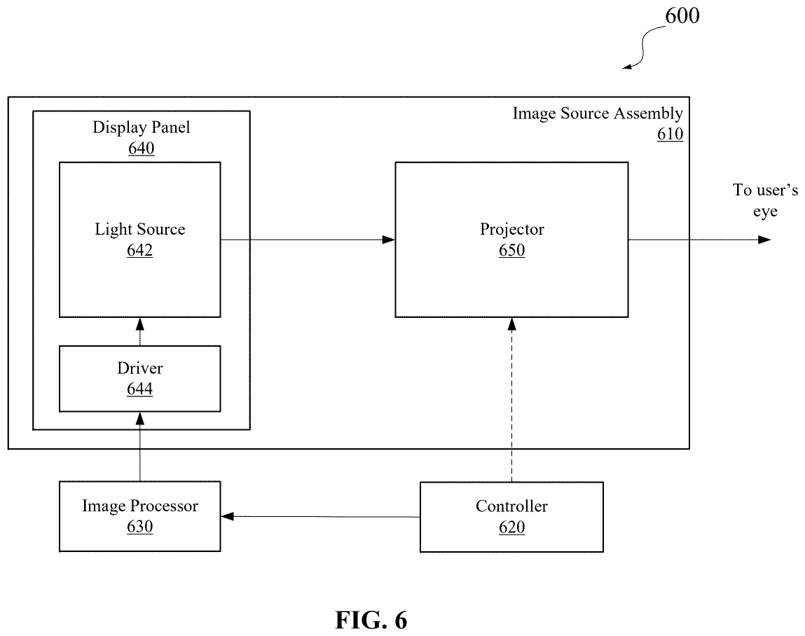

FIG. 5 illustrates an example of an optical system 500 with a non-pupil forming configuration for a near-eye display device according to certain embodiments. Optical system 500 may be an example of near-eye display 400 and may include display optics 510 and an image source 520 (e.g., a display panel). Display optics 510 may function as a magnifier. FIG. 5 shows that image source 520 is in front of display optics 510. In some other embodiments, image source 520 may be located outside of the field of view of the user's eye 590. For example, one or more deflectors or directional couplers may be used to deflect light from an image source to make the image source appear to be at the location of image source 520 shown in FIG. 5. Image source 520 may be an example of display 412 described above. For example, image source 520 may include a two-dimensional array of light emitters, such as semiconductor micro-LEDs or micro-OLEDs. The dimensions and pitches of the light emitters in image source 520 may be small. For example, each light emitter may have a diameter less than 2 μm (e.g., about 1.2 μm) and the pitch may be less than 2 μm (e.g., about 1.5 μm). As such, the number of light emitters in image source 520 can be equal to or greater than the number of pixels in a display image, such as 960×720, 1280×720, 1440×1080, 1920×1080, 2160×1080, or 2560×1080 pixels. Thus, a display image may be generated simultaneously by image source 520.

Light from an area (e.g., a pixel or a light emitter) of image source 520 may be directed to a user's eye 590 by display optics 510. Light directed by display optics 510 may form virtual images on an image plane 530. The location of image plane 530 may be determined based on the location of image source 520 and the focal length of display optics 510. A user's eye 590 may form a real image on the retina of user's eye 590 using light directed by display optics 510. In this way, objects at different spatial locations on image source 520 may appear to be objects on an image plane far away from user's eye 590 at different viewing angles. Image source 520 may have a size larger or smaller than the size (e.g., aperture) of display optics 510. Some light emitted from image source 520 with large emission angles (as shown by light rays 522 and 524) may not be collected and directed to user's eye 590 by display optics 510 and may become stray light.

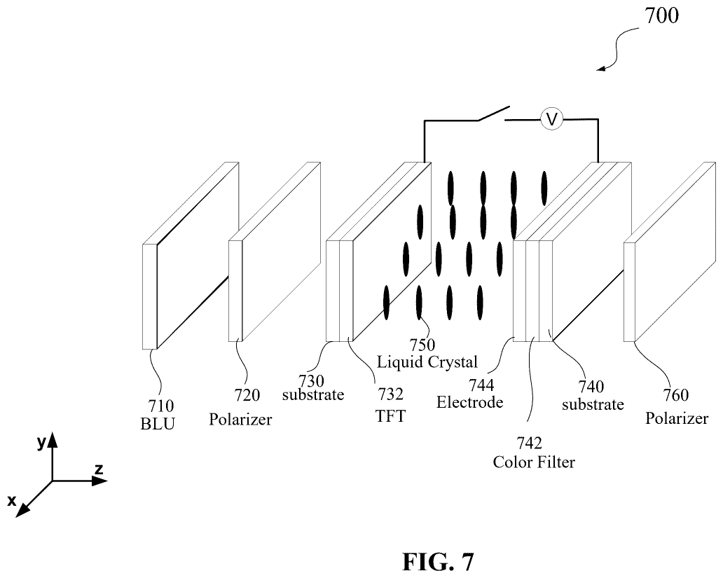

FIG. 6 illustrates an example of an image source assembly 610 in a near-eye display system 600 according to certain embodiments. Image source assembly 610 may include, for example, a display panel 640 that may generate display images to be projected to a user's eyes, and a projector 650 that may project the display images generated by display panel 640 to the user's eye. Display panel 640 may include a light source 642 and a drive circuit 644 for controlling light source 642. Light source 642 may include, for example, LEDs, OLEDs, micro-OLEDs, micro-LEDs, resonant cavity light emitting diodes (RC-LEDs), or other light emitters. Projector 650 may include, for example, a diffractive optical element, a freeform optical element, a scanning mirror, and/or other display optics. In some embodiments, near-eye display system 600 may also include a controller 620 that synchronously controls light source 642 and projector 650 (e.g., including a scanner). Image source assembly 610 may generate and output an image to user's eyes.

Light source 642 may include a plurality of light emitters arranged in an array or a matrix. Each light emitter may emit monochromatic light, such as red light, blue light, green light, infra-red light, and the like. While RGB colors are often used, embodiments described herein are not limited to using red, green, and blue as primary colors. Other colors can also be used as the primary colors of near-eye display system 600. In some embodiments, a display panel in accordance with an embodiment may use more than three primary colors. Each pixel in light source 642 may include three subpixels that include a red LED, a green LED, and a blue LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer.

Controller 620 may control the image rendering operations of image source assembly 610, such as the operations of light source 642 and/or projector 650. For example, controller 620 may determine instructions for image source assembly 610 to render one or more display images. The instructions may include display instructions and/or scanning instructions. In some embodiments, the display instructions may include an image file (e.g., a bitmap file). The display instructions may be received from, for example, a console, such as console 110 described above with respect to FIG. 1. Controller 620 may include a combination of hardware, software, and/or firmware not shown here so as not to obscure other aspects of the present disclosure. In some embodiments, controller 620 may be a graphics processing unit (GPU) of a display device. In other embodiments, controller 620 may be other kinds of processors.

Image processor 630 may be a general-purpose processor and/or one or more application-specific circuits that are dedicated to performing the features described herein. In one example, a general-purpose processor may be coupled to a memory to execute software instructions that cause the processor to perform certain processes described herein. In another embodiment, image processor 630 may be one or more circuits that are dedicated to performing certain features. While image processor 630 in FIG. 6 is shown as a stand-alone unit that is separate from controller 620 and drive circuit 644, image processor 630 may be a sub-unit of controller 620 or drive circuit 644 in other embodiments. In other words, in those embodiments, controller 620 or drive circuit 644 may perform various image processing functions of image processor 630. Image processor 630 may also be referred to as an image processing circuit.

In the example shown in FIG. 6, light source 642 may be driven by drive circuit 644, based on data or instructions (e.g., display and scanning instructions) sent from controller 620 or image processor 630. In one embodiment, drive circuit 644 may include a circuit panel that connects to and mechanically holds various light emitters of light source 642. Light source 642 may emit light in accordance with one or more illumination parameters that are set by the controller 620 and potentially adjusted by image processor 630 and drive circuit 644. The illumination parameters may be used by light source 642 to generate light. The illumination parameters may include, for example, source wavelength, pulse rate, pulse amplitude, beam type (continuous or pulsed), other parameter(s) that may affect the emitted light, or any combination thereof. In some embodiments, the source light generated by light source 642 may include multiple beams of red light, green light, and blue light, or any combination thereof.

Projector 650 may perform a set of optical functions, such as focusing, combining, conditioning, or scanning the image light generated by light source 642. In some embodiments, projector 650 may include a combining assembly, a light conditioning assembly, or a scanning mirror assembly. Projector 650 may include one or more optical components that optically adjust and potentially re-direct the light from light source 642. One example of the adjustment of light may include conditioning the light, such as expanding, collimating, correcting for one or more optical errors (e.g., field curvature, chromatic aberration, etc.), some other adjustments of the light, or any combination thereof. The optical components of projector 650 may include, for example, lenses, mirrors, apertures, gratings, polarizers, waveplates, prisms, or any combination thereof.

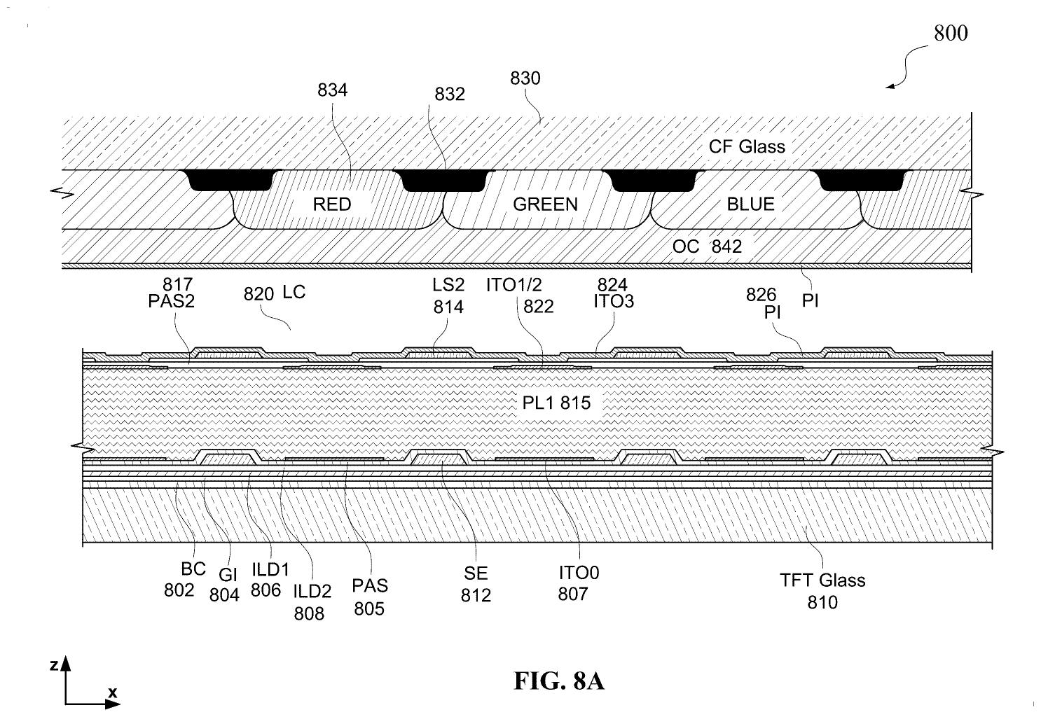

FIG. 7 illustrates an example of an LCD 700. As illustrated, LCD 700 may include a backlight unit (BLU) 710 configured to emit light (e.g., a light source for emitting white light), a first polarizer 720 configured to control the type of light that can pass through (e.g., control the polarization state of the light), and an LC panel that may modulate the incident light. The LC panel may include a first substrate 730, a thin-film transistor (TFT) array 732 including circuits for controlling the intensity of each pixel (e.g., by controlling the orientations of the liquid crystal molecules in a liquid crystal layer, thereby controlling the rotation angle of the polarization direction of the incident light), one or more liquid crystal layers 750, a common electrode 744, a color filter/black-mask array 742, and a second substrate 740. LCD 700 may also include a second polarizer 760 (e.g., a linear polarizer) configured to filter the light from the LC panel according to the polarization state of the output light from the LC panel. In some embodiments, BLU 710 may include one or more cold-cathode fluorescent lamps configured to emit light, or may include blue light-emitting diodes and quantum dots or phosphors for converting some blue light into green or red light, thereby generating white light. As described in detail below, in some embodiments, a black-mask layer with an array of apertures may be formed on TFT array 732. The color filter/black-mask array 742 may also include a black-mask layer and a plurality of color filter elements in the black-mask layer. The color filter elements may be used to form a plurality of color sub-pixels (e.g., including red, green, and/or blue sub-pixels). For example, the center of each color filter element of the plurality of color filter elements may be aligned with the center of a respective aperture of the array of apertures in the black-mask layer formed on TFT array 732, such that light passing through the aperture may be modulated by liquid crystal molecules (controlled by a TFT pixel) and filtered by the color filter element to form a color sub-pixel.

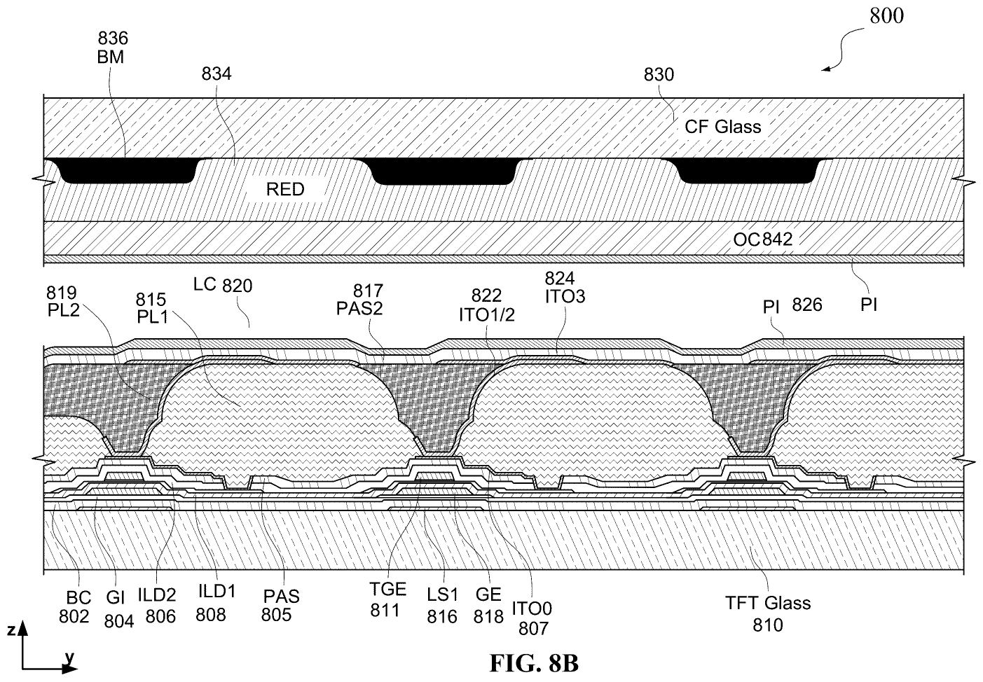

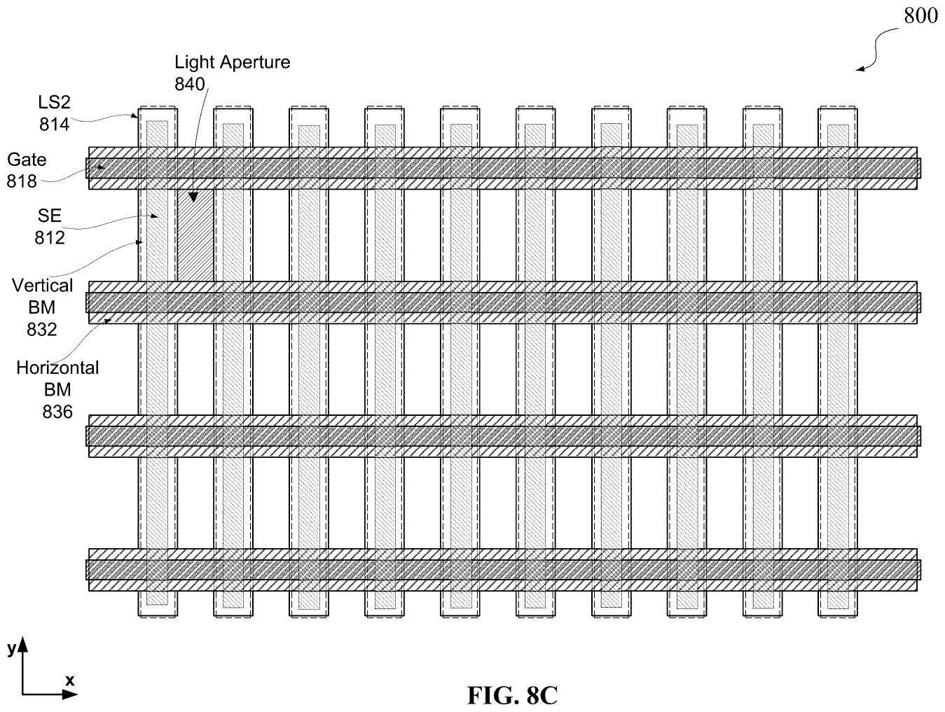

FIGS. 8A and 8B include cross-sectional views of an example of an LCD panel 800. FIG. 8A may be the cross-sectional view of LCD panel 800 along a horizontal (e.g., x) direction, whereas FIG. 8B may be the cross-sectional view of LCD panel 800 along a vertical (e.g., y) direction. FIG. 8C is a top view of the example of LCD panel 800. In the illustrated example, LCD panel 800 may include a TFT glass 810 that includes TFT circuits fabricated thereon. LCD panel 800 may also include a color filter glass 830 that includes a black matrix (BM) (also referred to as a black mask) and color filters 834 (e.g., red, green, and blue color filters) fabricated thereon. The black matrix may include vertical BM 832 (extending in the y direction) and horizontal BM 836 (extending in the x direction). A liquid crystal material layer 820 may be sandwiched by TFT glass 810 and color filter glass 830. Even though not shown in FIGS. 8A-8C, LCD panel 800 may also include spacers to separate the TFT glass 810 and color filter glass 830 and define the thickness of liquid crystal material layer 820.

FIG. 8A-8C show that TFT glass 810 may include bottom light shields 816 (LS1), a bottom coating layer 802 (BC), a gate insulation layer 804 (GI), gate electrodes 818 (GE), a first inter-layer dielectric layer 806 (ILD1), top gate electrodes 811 (TGE), a second dielectric layer 808 (ILD2), source electrodes 812 (SE), a passivation layer 805 (PAS), an ITO layer 807 (ITO0), a first planarization layer 815 (PL1), a second planarization layer 819 (PL2), ITO layers 822 (ITO1/2), a second passivation layer 817 (PAS2), an ITO layer 824 (ITO3), top light shields 814 (LS2), and a polyimide layer 826 (PI) formed thereon. Color filter glass 830 may include the black matrix, color filters 834, an overcoat layer 842 (OC), and another polyimide layer 826 (PI) formed thereon.

As illustrated, the TFT circuits on TFT glass 810 may include light blocking/shielding structures such as source electrodes 812, gate electrodes 818, light shields 816 (LS1), and light shields 814 (LS2). In LCD panel 800, source electrodes 812 and top light shields 814 (LS2) may be approximately aligned with vertical black matrix 832 (as shown in FIGS. 8A and 8C), while gate electrodes 818 and bottom light shields 816 (LS1) may be approximately aligned with horizontal black matrix 836 (as shown in FIGS. 8B and 8C). As such, light apertures 840 between the light shield structures on TFT glass 810 may be approximately aligned (e.g., center-to-center) with color filters 834. In high-resolution LCD panels, the pitch of the pixels may be small, and thus the light shield structures and the black matrix elements may have small sizes. Therefore, there may be misalignments between the light shield structures on TFT glass 810 and the black matrix elements on color filter glass 830 due to, for example, limited accuracy of the alignment process during the assembling of an LCD panel.

As described above, display panels are generally designed to have uniform viewing angle properties, where the light beam emitted by each region of the display panel may have a certain (e.g., Gaussian) beam profile with the peak luminance direction perpendicular to the display panel. However, in near-eye display systems, the user's viewing angle and the chief-ray angle (CRA) for different regions or different FOVs of a display panel (e.g., LCD or OLED display panel) may vary across the display panel. For example, the chief ray for the center region of an LCD panel may be in the surface-normal direction of the LCD panel, but the chief ray for other regions of the LCD panel may be tilted at different angles with respect to the surface-normal direction of the LCD panel. The mismatch between the display peak luminance angle and the chief ray angle may lead to brightness variations, which may also vary with the user's gaze direction.

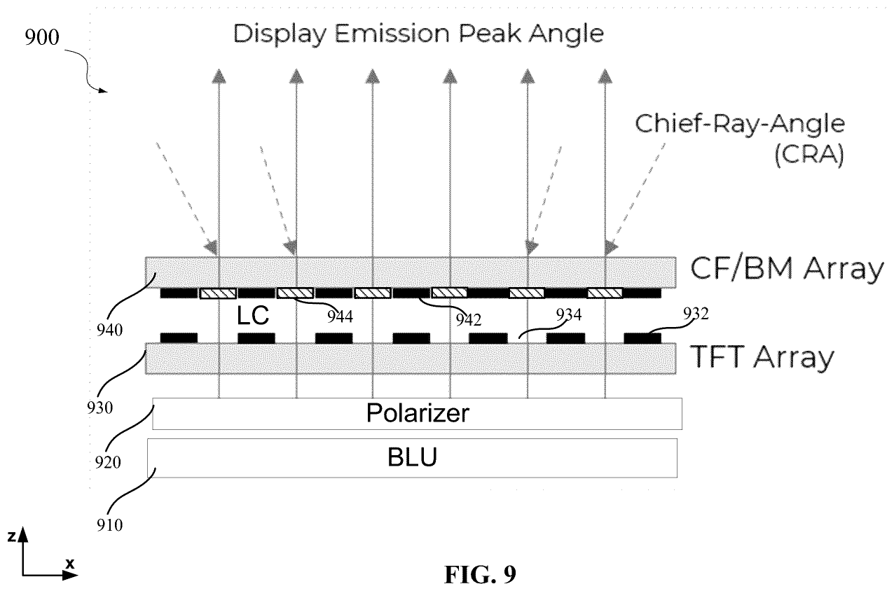

FIG. 9 illustrates an example of a mismatch between the display peak emission angle of an LCD panel 900 of a near-eye display and the chief-ray angles of the near-eye display for some regions of LCD panel 900. LCD panel 900 may include a BLU 910, a polarizer 920, a TFT array 930 including a light shielding layer 932 and an array of apertures 934 formed thereon, and a CF/BM array 940 including a black matrix 942 and an array of color filter elements 944 between black matrix elements of black matrix 942. Color filter elements 944 may include red, green, and blue color filters. Centers of color filter elements 944 may align with centers of apertures 934 in light shielding layer 932 on TFT array 930.

As shown in FIG. 9, display panels are generally designed to have uniform viewing angle properties, where the light beam emitted by each region of the display panel may have, for example, a Gaussian beam profile with the peak luminance direction perpendicular to the display panel. However, the user's viewing angle (and the chief ray angle) for a region of the display panel may vary across the display panel. For example, as illustrated, the chief ray for the center region of LCD panel 900 may be in the surface-normal direction of LCD panel 900, but the chief rays for other regions of LCD panel 900 may be tilted at different angles with respect to the surface-normal direction of LCD panel 900. The mismatch between the display peak luminance angle and the chief ray angle can lead to brightness variations, which may also depend on the user's gaze direction.

A near-eye display may also include display optics (also referred to as viewing optics) that collect display light from the display panel and project the displayed image to user's eyes. For example, pancake lenses or other folded optics may be used in near-eye displays to achieve thin form factor and light weight. The light collection efficiency of a pancake lens may depend on the emission profile of the display, the incident angle of the display light, and the location of the light emission region on the display, and the like. For example, the chief rays from different regions of the display panel may be incident on the pancake lens at different incident angles, and the reflectivity of a reflective surface of the pancake lens may be a function of the incident angle of light incident on the reflective surface. In addition, the display optics may have different light collection cones for pixels at different regions of the display panel. Therefore, there may be perceived brightness drop due to the different incident angles of the display light from different regions of the display panel, in addition to the mismatch between the lens collection angle and the peak emission angle of the display light emission profile that may have a limited full-width half-magnitude (FWHM) range, and the different light collection cones of the display optics for pixels at different regions of the display. As such, when the user's eye fixates at about 0°, due to the surface-normal peak emission, the different chief ray angles of the pixels, and the different light collection cones of the display optics for different pixels, pixels at peripheral regions of the display panel may appear dimmer than the pixels at the center of the optical axis, even if these pixels have the same emission profile and same peak luminance at the surface-normal direction. When the eye fixation angle changes, the chief ray angles and the light collection cones for the pixels of the display panel may also change, and thus the perceived brightness for different regions may change as well. Therefore, the perceived brightness may vary depending on the FOV and the user's gaze direction. This phenomenon of perceived brightness changes or brightness non-uniformity across the FOV of a near-eye display (e.g., VR, AR, or MR) device may be referred to as the brightness roll-off (BRO) effect, and may result in a perceived FOV narrower than the target FOV.

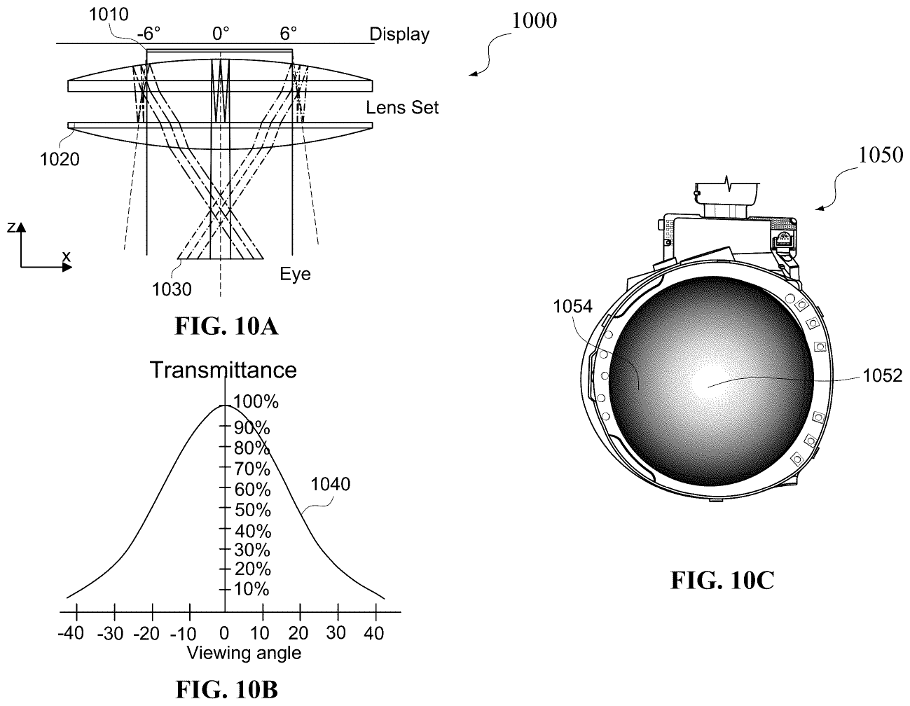

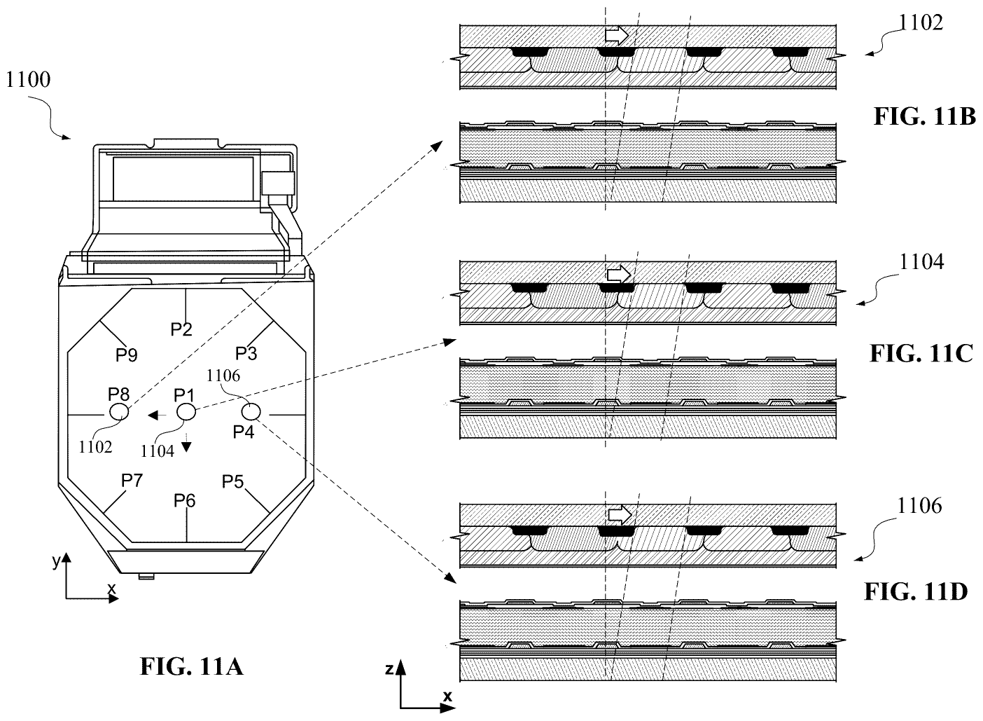

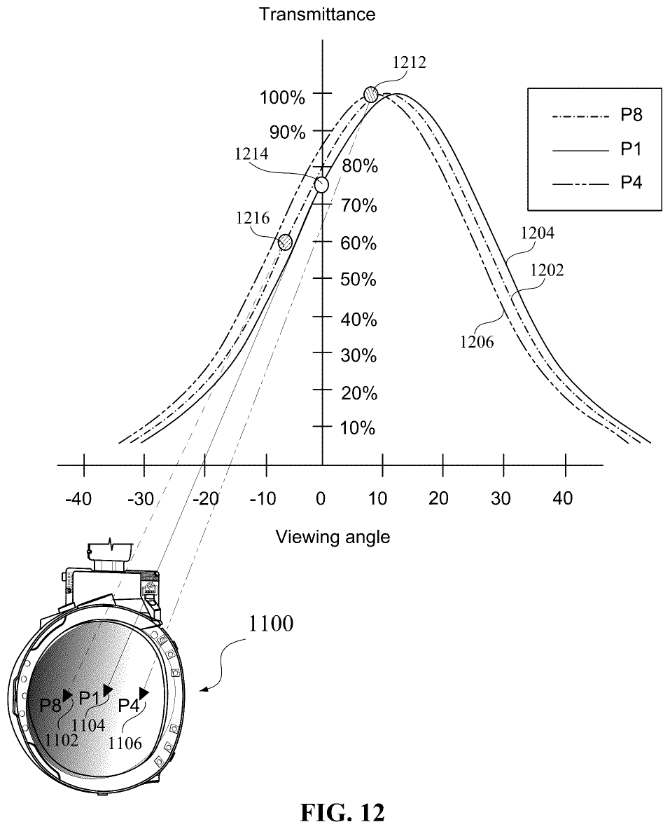

FIG. 10A illustrates an example of a near-eye display 1000 that includes a display panel 1010 (e.g., LCD panel 800 or 900) and display optics 1020 (or viewing optics). Display panel 1010 may generate display images, which may be projected onto a user's eye 1030 by display optics 1020, such as a folded lens (e.g., pancake lens). In near-eye display 1000, the chief ray angles (or viewing angles) for different regions of display panel 1010 seen by user's eye 1030 may be additionally changed by display optics 1020, compared with LCD panel 900 shown in FIG. 9. Thus, in near-eye display 1000, the chief ray angles (or viewing angles) seen through display optics 1020 may also be different for different regions of display panel 1010. In the illustrated example, the viewing angles for the center region of display panel 1010 seen through display optics 1020 may be about 0°, but the viewing angles (e.g., chief ray angles) for the peripheral regions of display panel 1010 seen through display optics 1020 may be about +/−6°, which may be changed to about +/−30° as seen by user's eye 1030 after passing through display optics 1020, thereby providing a field of view about 60° for user's eye 1030. It is noted that the example shown in FIG. 10A is for illustration purposes only. In other designs, the viewing angles of the peripheral regions of the display panel before and after the display optics may be different, depending on, for example, the sizes and relative position of the display panel and the display optics, the focal length of the display optics, the target field of view, and the like.

FIG. 10B illustrates an example of a relationship between the display luminance (or perceived brightness) and the viewing angle (or tilt angle) of near-eye display 1000 of FIG. 10A. A curve 1040 in FIG. 10B illustrates the relative display luminance (or perceived brightness) of a region of an LCD panel as a function of the viewing angle. Curve 1040 shows that, when the TFT glass and the color filter glass are approximately aligned, the maximum luminance may be at about 0° viewing angle, and the luminance may gradually decrease as the viewing angle increases. When the TFT glass and the color filter glass are not properly aligned, the maximum luminance angle may not be at about 0°, and the variation of the luminance or perceived brightness with the change of the viewing angle may be different from the example shown in FIG. 10B.

FIG. 10C illustrates an example of display luminance variation across the field of view of an example of a near-eye display 1050. As illustrated, some regions 1052 (e.g., the center region) of a display panel (e.g., a display panel for the left eye) of near-eye display 1050 may appear to be brighter than other regions 1054 (e.g., peripheral regions) of the display panel to the user's eye.

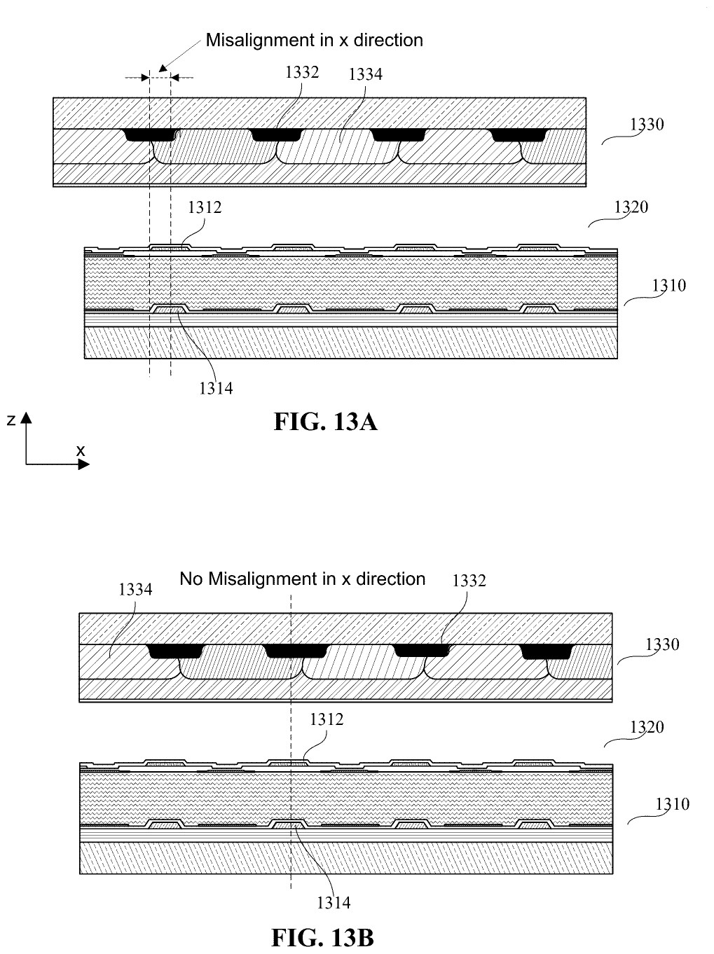

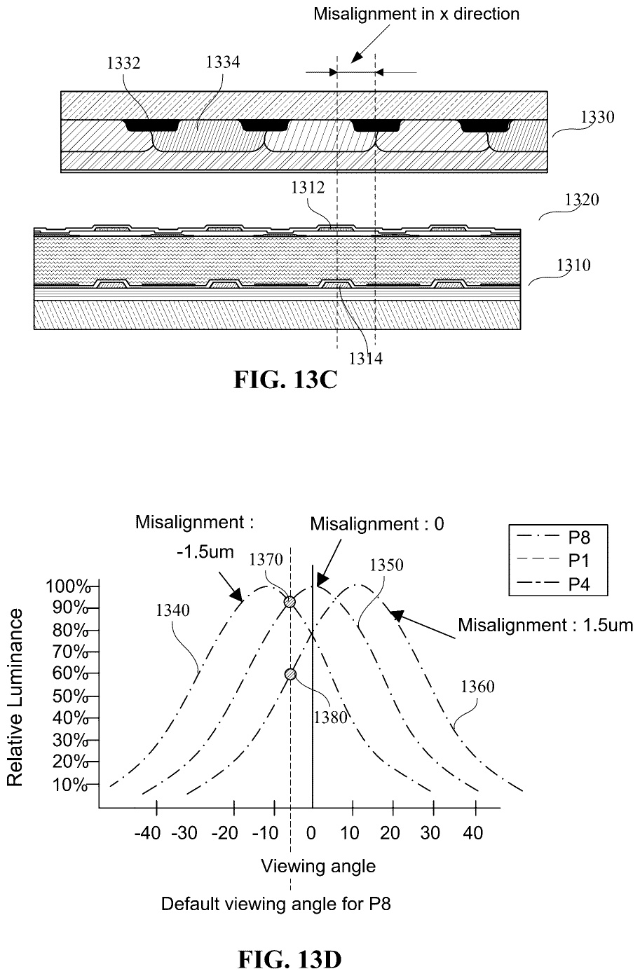

FIG. 11A illustrates an example of a display panel 1100 of a near-eye display. Display panel 1100 may include a plurality of regions, such as a center region P1 and peripheral regions P2-P9 illustrated in FIG. 11A. As described above, when the resolution of display panel 1100 is high, the pitch of the pixels may be small, and thus the light shield structures and the black matrix elements may have small sizes. Therefore, there may be misalignments between the light shield structures on the TFT glass and the black matrix elements on the color filter glass due to fabrication inaccuracy or errors of the TFT glass and/or the color filter glass, and the alignment errors between the TFT glass and the color filter glass during the assembling of the TFT glass and color filter glass to form the display panel. When there is a misalignment between the light shield structures on the TFT glass and the black matrix elements on the color filter glass, the maximum luminance or brightness may not be perceived at about 0° viewing angle.

FIGS. 11B-11D illustrate examples of the maximum transmittance angles at different regions of the near-eye display of FIG. 11A having different misalignments between thin-film transistors (and light shield structures) and color filters. For example, FIG. 11B shows the misalignment (e.g., about 1.7 μm) between the black matrix elements on the color filter glass and the corresponding source electrodes (e.g., source electrodes 812) and light shields (e.g., top light shields 814) on the TFT glass at region P8 (1102), and the corresponding maximum transmittance angle (which is different from) 0° at region P8. FIG. 11C shows the misalignment (e.g., about 1.4 μm) between the black matrix elements on the color filter glass and the corresponding source electrodes and light shields on the TFT glass at region P1 (1104), and the corresponding maximum transmittance angle (which is different from) 0° at region P1. FIG. 11D shows the misalignment (e.g., about 1.5 μm) between the black matrix elements on the color filter glass and the corresponding source electrodes and light shields on the TFT glass at region P4 (1106), and the corresponding maximum transmittance angle (which is different from) 0° at region P4.

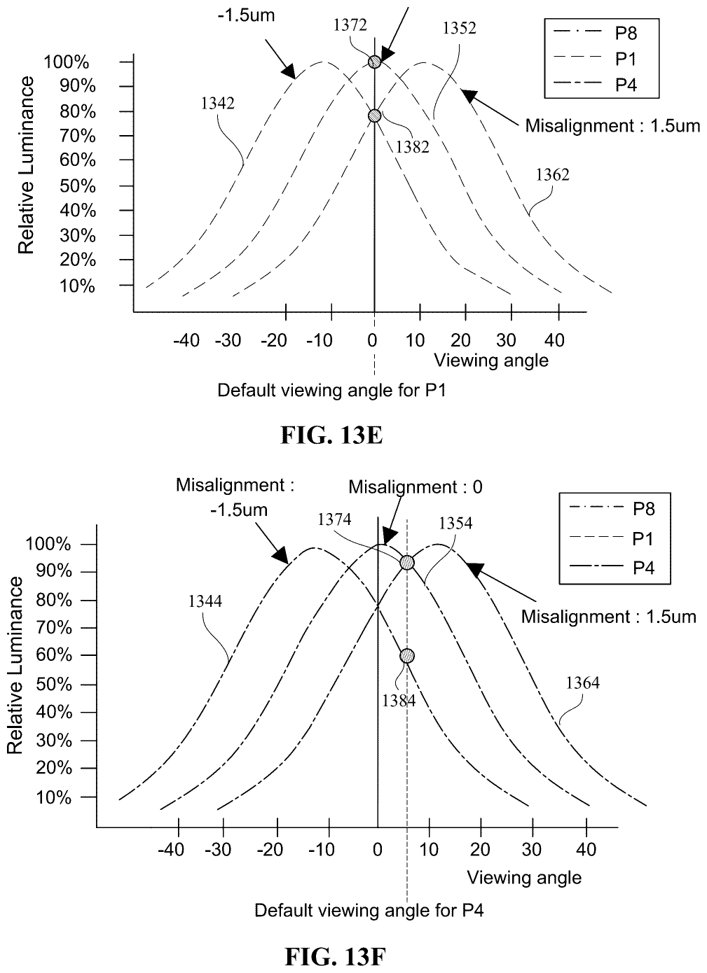

FIG. 12 illustrates an example of display brightness variation in the example of display panel 1100 of the near-eye display of FIGS. 11A-11D. A curve 1202 in FIG. 12 shows the variation of the display brightness of region P8 (1102) with the change of the user's viewing angle (e.g., chief ray angle), a curve 1204 shows the variation of the display brightness of region P1 (1104) with the change of the user's viewing angle, whereas a curve 1206 shows the variation of the display brightness of region P4 (1106) with the change of the user's viewing angle. As shown in FIGS. 11B-12, due to the different positive shifts (e.g., 1.4 μm, 1.5 μm, and 1.7 μm, respectively) at regions P1 (1104), P4 (1106), and P8 (1102), the display luminance curve as shown in FIG. 10B may be shifted to the right by different angles. Therefore, the peak transmittance or luminance angles at regions P1, P4, and P8 may not be at about 0° viewing angle, but may be at different positive viewing angles. In addition, the user's viewing angles for regions P1, P4, and P8 may be different as described above. For example, in the example shown in FIG. 10A, the user's viewing angle for region P1 may be about 0°, the user's viewing angle for region P8 may be about −6°, whereas the user's viewing angle for region P4 may be about +6°. As such, the luminance perceived by the user may be high for region P4 (e.g., with a relative luminance close to about 100% as shown by a data point 1212 in the illustrated example) because the user's viewing angle is close to the peak luminance angle. The luminance perceived by the user may be lower for region P1 (e.g., with a relative luminance about 75% as shown by a data point 1214 in the illustrated example) due to a mismatch between the user's viewing angle and the peak luminance angle. The luminance perceived by the user may be even lower for region P8 (e.g., with a relative luminance about 60% only as shown by a data point 1214 in the illustrated example) due to a larger mismatch between the user's viewing angle and the peak luminance angle.

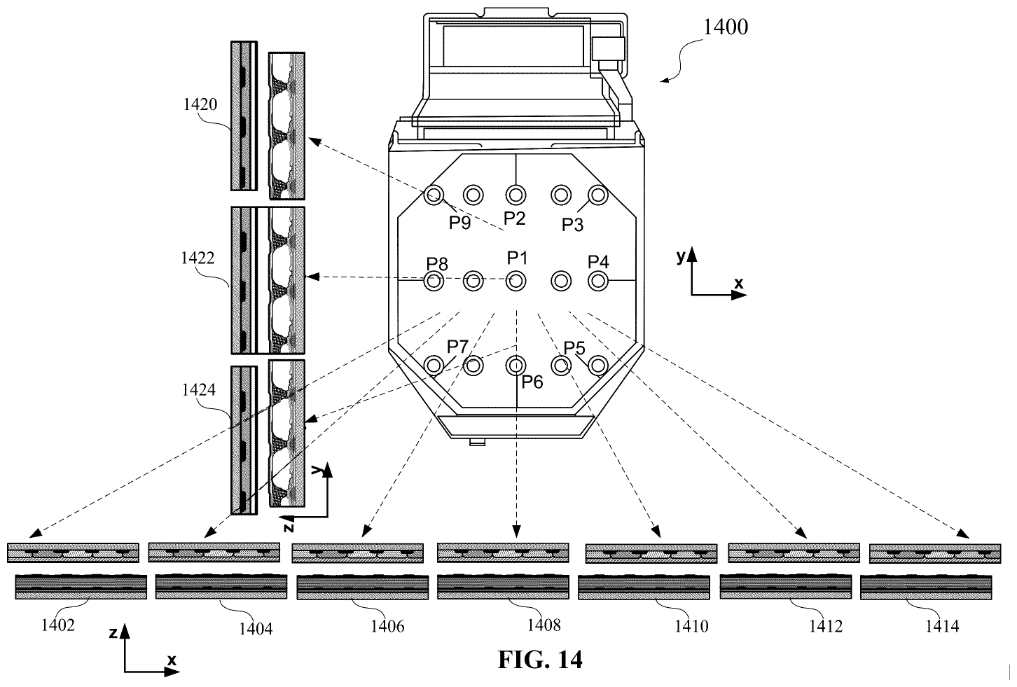

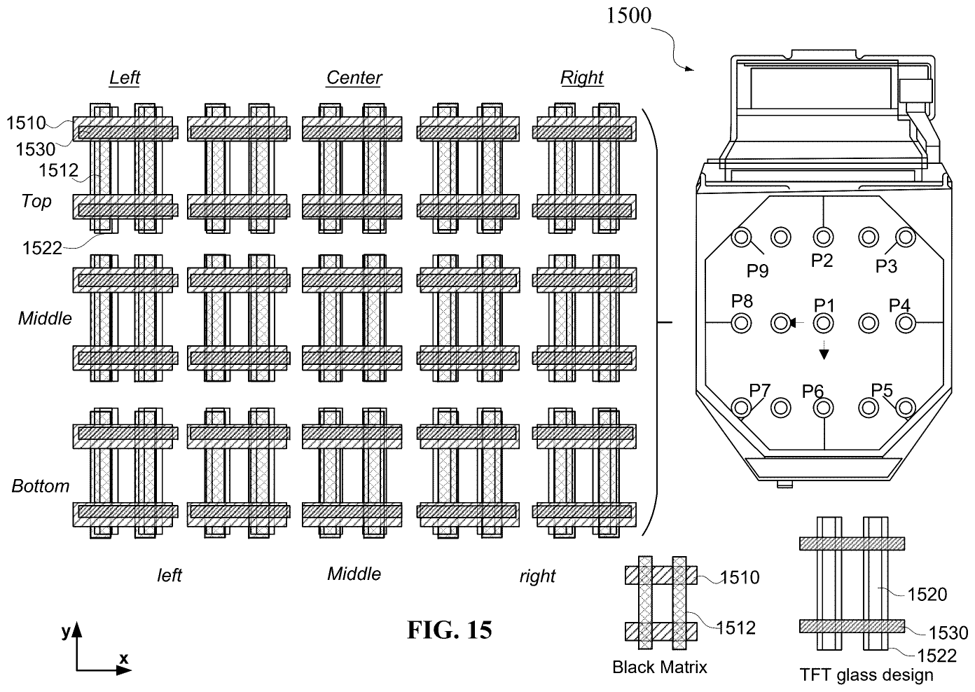

FIGS. 13A-13C show different offsets (e.g., misalignments) between thin-film transistors and color filters in an LCD panel. The LCD panel may include a first assembly 1310, a second assembly 1330, and a liquid crystal material layer 1320 between first assembly 1310 and second assembly 1330. As described above, first assembly 1310 may include TFT circuits formed on a substrate (e.g., a glass substrate) and may include light shields 1312 and electrodes 1314 (e.g., source electrodes) that may block visible light. Second assembly 1330 may include black matrix elements 1332 and color filters 1334 formed on another substrate (e.g., another glass substrate). FIG. 13A shows an example of a region (e.g., region P8 in FIG. 11A) of the LCD panel where color filters 1334 and black matrix elements 1332 are shifted in the x direction by about −1.5 μm with respect to the corresponding electrodes 1314 and light shields 1312 due to design and/or misalignment. FIG. 13B shows an example of a region (e.g., region P1 in FIG. 11A) of the LCD panel where color filters 1334 and black matrix elements 1332 are aligned with the corresponding electrodes 1314 and light shields 1312. FIG. 13C shows an example of a region (e.g., region P4 in FIG. 11A) of the LCD panel where color filters 1334 and black matrix elements 1332 are shifted in the x direction by about +1.5 μm with respect to the corresponding electrodes 1314 and light shields 1312.

FIGS. 13D-13F show examples of display luminance variation for different regions of the LCD panel having different offsets (e.g., misalignments) between the thin-film transistors and color filters (and between the light shields and the black matrix elements). For example, FIG. 13D shows three examples of relative angular luminance curves 1340, 1350, and 1360 for region P8 of display panel 1100 when the offsets between the color filters (and black matrix elements) and the corresponding electrodes (e.g., source electrodes) and light shields (e.g., LS2) on the TFT glass are about −1.5 μm, 0 μm, and +1.5 μm, respectively. As illustrated, with different offset values, the display luminance curves (and the peak luminance angles) may be shifted to the left or right by different angles. Because the user's default viewing angle for region P8 may be about −6° in the illustrated example, the relative luminance of region P8 perceived by the user may be higher than 90% if the offset is about −1.5 μm or about 0 μm as shown by a data point 1370. However, if the manufacturing inaccuracy or other errors cause an offset about +1.5 μm at region P8, the relative luminance of region P8 perceived by the user may be only about 60% as shown by a data point 1380, due to the large mismatch between the view angle of region P8 and the peak luminance angle of region P8.

FIG. 13E shows three examples of relative angular luminance curves 1342, 1352, and 1362 for region P1 of display panel 1100 when the offsets between the color filters (and black matrix elements) and the corresponding electrodes (e.g., source electrodes) and light shields (e.g., LS2) on the TFT glass are about −1.5 μm, 0 μm, and +1.5 μm, respectively. As illustrated, with different offset values, the display luminance curves (and the peak luminance angles) may be shifted to the left or right by different angles. Because the user's default viewing angle for region P1 may be about 0° in the illustrated example, the relative luminance of region P1 perceived by the user may be higher (e.g., close to 100%) if the misalignment is about 0 μm as shown by a data point 1372. If the manufacturing inaccuracy or errors cause a misalignment about +1.5 μm or −1.5 μm at region P1, the relative luminance of region P1 perceived by the user's eye may be below about 80% as shown by a data point 1382.

FIG. 13F shows three examples of relative angular luminance curves 1344, 1354, and 1364 for region P4 of display panel 1100 when the offsets between the color filters (and black matrix elements) and the corresponding electrodes (e.g., source electrodes) and light shields (e.g., LS2) on the TFT glass are about −1.5 μm, 0 μm, and +1.5 μm, respectively. As illustrated, with different offset values, the display luminance curves (and the peak luminance angles) may be shifted to the left or right by different angles. Because the user's default viewing angle for region P4 may be about +6°, the relative luminance of region P4 perceived by the user may be higher than 90% if the misalignment is about +1.5 μm or about 0 μm as shown by a data point 1374. However, if the manufacturing misalignments or other errors cause an offset between the color filters and the corresponding electrodes about −1.5 μm at region P4, the relative luminance of region P4 perceived by the user's eye may be only about 60% as shown by a data point 1384, due to the due to the large mismatch between the view angle of region P4 and the peak luminance angle of region P4.

According to certain embodiments disclosed herein, an LCD panel may be designed to have the peak luminance angle matching the corresponding viewing angle (e.g., chief ray angle) seen through display optics (e.g., a lens such as a pancake lens) across regions of the display panel. For example, the viewing angle of each region of a plurality of regions of the display panel seen though the display optics may be determined based on the configuration of the near-eye display. The offset between the color filters and the TFT circuits at each region of the plurality of regions to achieve peak luminance at the corresponding viewing angle may then be determined based on the desired peak luminance angle (which matches the viewing angle or chief ray angle) at the region. The color filters at each region may then be shifted with respect to the TFT circuits based on the determined offset to achieve peak luminance at the corresponding viewing angle through the display optics. In this way, the BRO effect or other brightness variations in the field of view can be reduced, even if there are some misalignment errors between the TFT glass and the color filter glass.

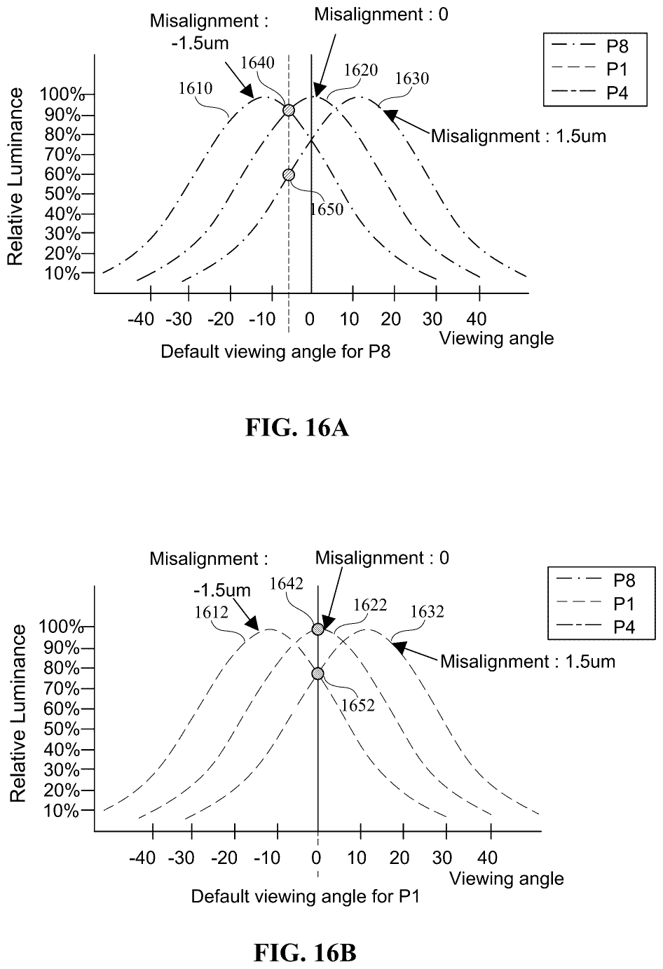

FIG. 14 illustrates an example of an LCD panel 1400 with a variable shift between thin-film transistors and color filters according to certain embodiments. LCD panel 1400 may be similar to the LCD panels described above, but may have preset shifts between the thin-film transistors and color filters (and between TFT electrodes/light shields and black matrix elements). In the illustrated example, the color filters (and black matrix elements) on the color filter glass may be intentionally shifted with respect to the corresponding electrodes (e.g., source or gate electrodes) and light shields (e.g., LS1 or LS2) on the TFT glass. The amount of shift may vary across the different regions. For example, as illustrated, in the x direction (e.g., horizontal direction), the shift of the black matrix elements with respect to the corresponding source electrodes (and LS2) in the x direction may be about 0 μm at a region 1408 near the center region P1, and may have gradually increasing positive values for regions 1410, 1412, and 1414 to the right of the center region P1 and gradually decreasing negative values for regions 1406, 1404, and 1402 to the left of the center region P1. Similarly, in the vertical direction, the shift of the black matrix elements with respect to the corresponding gate electrodes (and LS1) may be about 0 μm at a region 1422 near the center region P1, and may have gradually increasing positive values for regions (e.g., a region 1420) above the center region P1 and gradually decreasing negative values for regions (e.g., a region 1424) below the center region P1. In this way, the peak luminance angle of a region of the display panel (with no manufacturing inaccuracy or errors) may be approximately aligned with the user's default viewing angle of the region, such that the relative luminance of the region perceived by the user may not drop to low values (e.g., below about 75% or 70%) even if there may be an additional misalignment caused by manufacturing inaccuracy or errors.

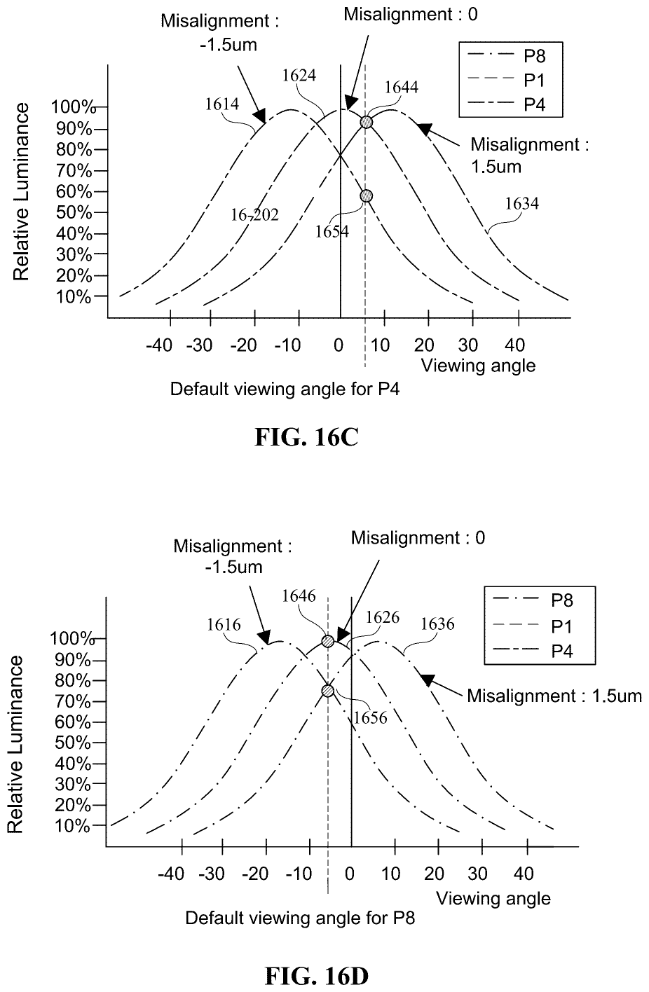

FIG. 15 illustrates an example of the variable shift between thin-film transistors and color filters of an LCD panel 1500 according to certain embodiments. LCD panel 1500 may be an example of LCD panel 1400. FIG. 15 may be a top view of LCD panel 1500. As illustrated, at the center region, the centers of horizontal BM elements 1510 may be aligned with the centers of corresponding gate electrodes 1530 in the y direction, and the centers of vertical BM elements 1512 may be aligned with the centers of the corresponding source electrodes 1520 and light shields 1522 in the x direction. In regions outside of the center region, the black matrix elements may be shifted outwardly with respect to the corresponding electrodes or light shields in both the horizontal direction and vertical direction. For example, in a top region along the y direction, horizontal BM elements 1510 may be shifted in the +y direction with respect to the corresponding gate electrodes 1530. In a bottom region along the y direction, horizontal BM elements 1510 may be shifted in the −y direction with respect to the corresponding gate electrodes 1530. In a left region along the x direction, vertical BM elements 1512 may be shifted in the −x direction with respect to source electrodes 1520 and light shields 1522. In a right region along the x direction, vertical BM elements 1512 may be shifted in the +x direction with respect to source electrodes 1520 and light shields 1522.

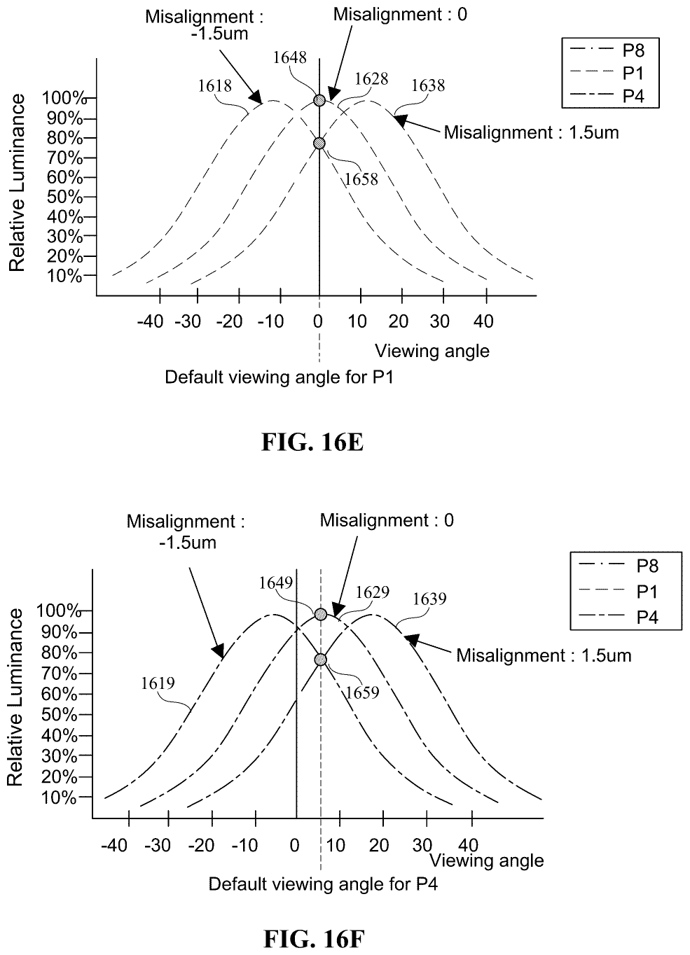

FIGS. 16A-16F illustrate examples of improving display luminance uniformity using an LCD panel with a variable shift between thin-film transistors and color filters according to certain embodiments. FIGS. 16A-16C show examples of angular luminance curves for different regions of an LCD panel without intentional shifts between thin-film transistors and color filters, such as display panel 800. FIGS. 16A-16C may be similar to FIGS. 13D-13F described above. FIGS. 16D-16F show examples of angular luminance curves for different regions of an LCD panel with an intentional, variable shift between thin-film transistors and color filters according to certain embodiments disclosed herein, such as LCD panel 1400 or 1500 described above.

FIG. 16A shows three examples of relative angular luminance curves 1610, 1620, and 1630 for region P8 of display panel 1100 when the misalignments between the color filters (and black matrix elements) and the corresponding electrodes (e.g., source electrodes) and light shields (e.g., LS2) on the TFT glass are about −1.5 μm, 0 μm, and +1.5 μm, respectively. As illustrated, with different misalignment values, the angular luminance curves (and the peak luminance angles) may be shifted to the left or right by different angles. Because the user's default viewing angle for region P8 may be about −6° in the illustrated example, the relative luminance of region P8 perceived by the user's eye may be higher than 90% if the misalignment is about −1.5 μm or about 0 μm as shown by a data point 1640. However, if the manufacturing inaccuracy or errors cause a misalignment about +1.5 μm at region P8, the relative luminance of region P8 perceived by the user's eye may be only about 60% as shown by a data point 1650, due to the large mismatch between the view angle of region P8 and the peak luminance angle of region P8.

FIG. 16B shows three examples of relative angular luminance curves 1612, 1622, and 1632 for region P1 of display panel 1100 when the misalignments between the color filters (and black matrix elements) and the corresponding electrodes (e.g., source electrodes) and light shields (e.g., LS2) on the TFT glass are −1.5 μm, 0 μm, and +1.5 μm, respectively. As illustrated, with different misalignment errors, the angular luminance curves (and the peak luminance angles) may be shifted to the left or right by different angles. Because the user's default viewing angle for region P1 may be about 0° in the illustrated example, the relative luminance of region P1 perceived by the user's eye may be higher (e.g., close to 100%) if the misalignment is about 0 μm as shown by a data point 1642. If the manufacturing inaccuracy or errors cause a misalignment about +1.5 μm or −1.5 μm at region P1, the relative luminance of region P1 perceived by the user's eye may be below about 80% as shown by a data point 1652.

FIG. 16C shows three examples of relative angular luminance curves 1614, 1624, and 1634 for region P4 of display panel 1100 when the misalignments between the color filters (and black matrix elements) and the corresponding electrodes (e.g., source electrodes) and light shields (e.g., LS2) on the TFT glass are −1.5 μm, 0 μm, and +1.5 μm, respectively. As illustrated, with different misalignment errors, the angular luminance curves (and the peak luminance angles) may be shifted to the left or right by different angles. Because the user's default viewing angle for region P4 may be about +6°, the relative luminance of region P4 perceived by the user's eye may be higher than 90% if the misalignment is about +1.5 μm or about 0 μm as shown by a data point 1374. However, if the manufacturing errors cause a misalignment about −1.5 μm at region P4, the relative luminance of region P4 perceived by the user's eye may be only about 60% as shown by a data point 1384, due to the large mismatch between the view angle of region P4 and the peak luminance angle of region P4.

FIG. 16D shows three examples of angular luminance curves 1616, 1626, and 1636 for a left region P8 of an LCD panel (e.g., LCD panel 1400 or 1500) where the color filters (and black matrix elements) may be intentionally shifted to the left (e.g., in the −x direction with a negative shift value) with respect to the corresponding electrodes and light shields on the TFT glass, and there might be misalignment errors about −1.5 μm, 0 μm, and +1.5 μm, respectively due to manufacturing errors or inaccuracy. As illustrated, with no misalignment caused by manufacturing inaccuracy or errors, angular luminance curve 1626 at region P8 may already be shifted to the left (with a peak luminance at a negative viewing angle corresponding to the viewing angle of region P8, such as about −6°) because of the intentional shift of the color filters (and black matrix elements) with respect to the corresponding electrodes and light shields on the TFT glass. With different misalignment values, the angular luminance curves (and the peak luminance angles) may be further shifted to the left or right by different angles. For example, with an additional misalignment error about −1.5 μm, the angular luminance curve (as shown by curve 1616) may be further shifted to the left with respect to angular luminance curve 1626 for zero misalignment error. With an additional misalignment error about +1.5 μm, the angular luminance curve (as shown by curve 1636) may be shifted to the right with respect to angular luminance curve 1626 for zero misalignment error. Because the viewing angle (e.g., chief ray angle) for region P8 is about −6° (matching the peak luminance angle) in the illustrated example, the relative luminance of region P8 perceived by the user's eye may be close to 100% when the misalignment error is zero as shown by a data point 1646, and may be about 75% even if the additional misalignment error is about +1.5 μm or −1.5 μm as shown by a data point 1656. Thus, the relative luminance of region P8 perceived by a user may be about 75% or higher as long as the additional misalignment error is between −1.5 μm and +1.5 μm.

FIG. 16E shows three examples of angular luminance curves 1618, 1628, and 1638 for a center region P1 of the LCD panel where the color filters (and black matrix elements) may be aligned with the corresponding electrodes and light shields on the TFT glass, and there might be misalignment errors about −1.5 μm, 0 μm, and +1.5 μm, respectively due to manufacturing inaccuracy or errors. As illustrated, with no misalignment caused by manufacturing inaccuracy or other errors, angular luminance curve 1628 at region P1 may have a peak luminance at a 0° (matching the viewing angle of region P1). With different misalignment errors, the angular luminance curves (and the peak luminance angles) may be shifted to the left or right by different angles. For example, with a misalignment error about −1.5 μm, the angular luminance curve (shown by curve 1618) may be shifted to the left with respect to angular luminance curve 1628 for zero misalignment error. With a misalignment error about +1.5 μm, the angular luminance curve (shown by curve 1638) may be shifted to the right with respect to angular luminance curve 1628 for zero misalignment error. Because the viewing angle for region P1 is about 0° in the illustrated example, the relative luminance of region P1 perceived by the user may be about 100% when the misalignment error is zero as shown by a data point 1648, and may be greater than about 75% even if the additional misalignment error is about +1.5 μm or −1.5 μm as shown by a data point 1658. Thus, the relative luminance of region P1 perceived by a user may be about 75% or higher as long as the additional misalignment error is between −1.5 μm and +1.5 μm.

FIG. 16F shows three examples of angular luminance curves 1619, 1629, and 1639 at a right region P4 of the LCD panel where the color filters (and black matrix elements) may be intentionally shifted to the right (e.g., in the +x direction with a positive shift value) with respect to the corresponding electrode and light shield on the TFT glass, and there might be additional misalignment errors about −1.5 μm, 0 μm, and +1.5 μm, respectively, due to manufacturing inaccuracy or other errors. As illustrated, with no misalignment caused by manufacturing errors, angular luminance curve 1629 at region P4 may already be shifted to the right (with a peak luminance at a positive viewing angle corresponding to the viewing angle of region P4, such as about +6°) because of the intentional shift of the color filters (and black matrix elements) with respect to the corresponding electrodes and light shields on the TFT glass. With different misalignment errors, the angular luminance curves (and the peak luminance angles) may be further shifted to the left or right by different angles. For example, with a misalignment error about −1.5 μm, the angular luminance curve (shown by curve 1619) may be shifted to the left with respect to angular luminance curve 1629 for zero misalignment error. With a misalignment error about +1.5 μm, the angular luminance curve (shown by curve 1639) may be further shifted to the right with respect to angular luminance curve 1629 for zero misalignment error. Because the viewing angle (e.g., chief ray angle) for region P4 seen through the display optics is about +6° (matching the peak luminance angle) in the illustrated example, the relative luminance of region P4 perceived by the user may be about 100% when the additional misalignment error is zero as shown by a data point 1649, and may be about 75% or higher when the additional misalignment error is about +1.5 μm or −1.5 μm as shown by a data point 1659. Thus, the relative luminance of region P4 perceived by a user may be about 75% or higher as long as the additional misalignment error is between −1.5 μm and +1.5 μm.

FIGS. 16D-16F show that, compared with the examples shown in FIGS. 16A-16C, intentionally shifting the black matrix with respect to the corresponding electrodes and light shields on the TFT glass by different values at different regions of the display panel such that the peak luminance angle at each region of the display panel matches the corresponding viewing angle (e.g., chief ray angle) of the region of the display panel can increase the minimum luminance and reduce the brightness variation (e.g., BRO) even if there may be some misalignments caused by the manufacturing inaccuracy or errors.

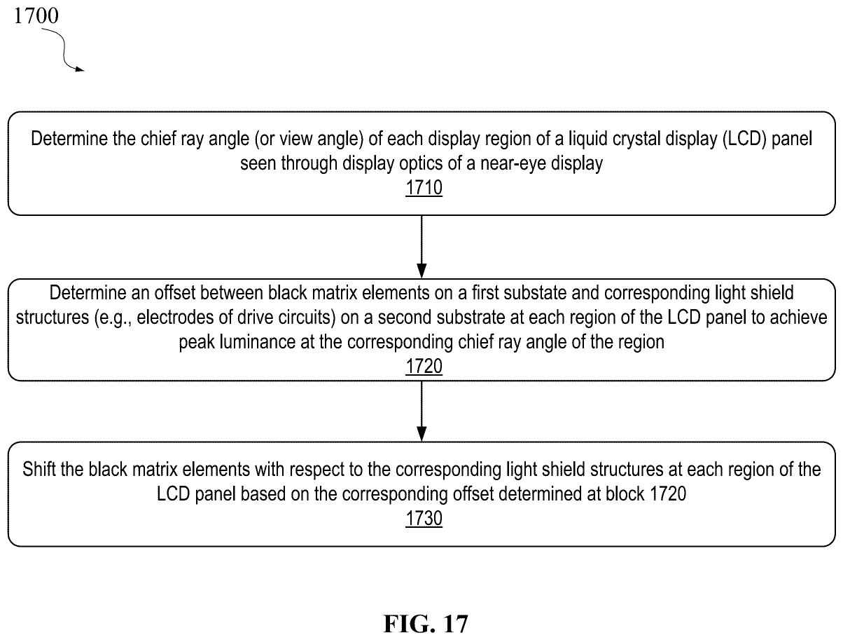

FIG. 17 includes a flowchart 1700 illustrating an example of a method of reducing brightness nonuniformity of a near-eye display according to certain embodiments. In the illustrated example, the method may include, at block 1710, determining the viewing angle (e.g., chief ray angle) of each display region of a display panel (e.g., an LCD panel) seen through display optics. As described above with respect to, for example, FIG. 10A, the viewing angle of each display region of the display panel may depend on, for example, the relative dimensions of the display panel and the display optics, the relative positions of the display panel and the display optics, the focal length of the display optics, the size of the eyebox, the distance between the display optics and the user's eye (or the eyebox) of the near-eye display, the desired field of view of the near-eye display, and the like. The viewing angle for a region of the display panel may be different before the display optics (as seen through the display optics) and after the display optics (as seen by user's eyes). In one example, the viewing angle of a region (e.g., region P8) of the display panel before the display optics (as seen through the display optics) may be about 6°, and the viewing angle of the region of the display panel after the display optics (as seen by the user's eye) may be about 30°, thereby providing a field of view greater than about +30° for an eye of the user.

At block 1720, an offset of the black matrix elements with respect to the corresponding light shield structures (e.g., electrodes or light shields) of the drive circuits at each region of the LCD panel to achieve peak luminance at the corresponding viewing angle for the region as determined at block 1710 may be determined. As described above with respect to, for example, FIGS. 11A-13 and 16A-16F, different amounts of offset between the black matrix elements and the corresponding light shield structures (e.g., gate electrodes, source electrodes, top light shields, bottom light shields, or a combination thereof) may cause the peak luminance angle of the angular luminance curve to shift by different angles. The relationship between (1) the amount of relative shift of the black matrix elements with respect to the corresponding light shield structures and (2) the change of the peak luminance angle may be determined for a particular near-eye display. The determined relationship and the desired shift of the peak luminance angle may then be used to determine the appropriate amount of offset between the black matrix elements and the corresponding light shield structures. As described above, because the user's viewing angle may gradually increase from the center region of the display panel to peripheral regions of the display panel, the desired shift of the peak luminance angle may also need to gradually increase from the center region of the display panel to peripheral regions of the display panel to match the user's viewing angle, and thus the relative shift between the black matrix elements and the corresponding light shield structures may also need to gradually increase from the center region of the display panel to peripheral regions of the display panel as shown in, for example, FIGS. 14 and 15.

At block 1730, at each region of the LCD panel, the black matrix elements may be shifted with respect to the corresponding light shield structures at each region of the LCD panel based on the offset determined ay block 1720, to achieve peak luminance at the corresponding viewing angle of the region, thereby improving the power efficiency and user experience. As shown by FIGS. 16A-16F, when the peak luminance angles are configured to match the user's viewing angles, the luminance variation across the field of view may be reduced and the minimum luminance level may be improved even if there are additional misalignment errors caused by the inaccuracy or errors of the manufacturing process.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

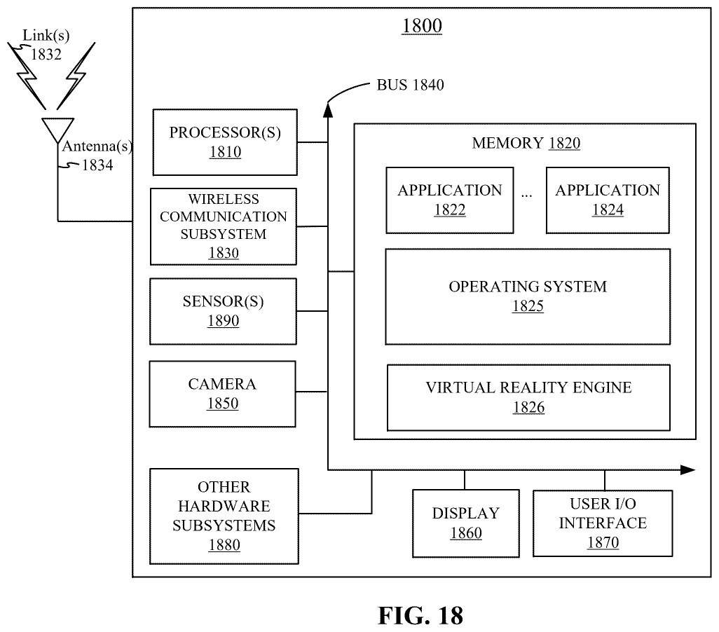

FIG. 18 is a simplified block diagram of an example electronic system 1800 of an example near-eye display (e.g., HMD device) for implementing some of the examples disclosed herein. Electronic system 1800 may be used as the electronic system of an HMD device or other near-eye displays described above. In this example, electronic system 1800 may include one or more processor(s) 1810 and a memory 1820. Processor(s) 1810 may be configured to execute instructions for performing operations at a number of components, and can be, for example, a general-purpose processor or microprocessor suitable for implementation within a portable electronic device. Processor(s) 1810 may be communicatively coupled with a plurality of components within electronic system 1800. To realize this communicative coupling, processor(s) 1810 may communicate with the other illustrated components across a bus 1840. Bus 1840 may be any subsystem adapted to transfer data within electronic system 1800. Bus 1840 may include a plurality of computer buses and additional circuitry to transfer data.

Memory 1820 may be coupled to processor(s) 1810. In some embodiments, memory 1820 may offer both short-term and long-term storage and may be divided into several units. Memory 1820 may be volatile, such as static random access memory (SRAM) and/or dynamic random access memory (DRAM) and/or non-volatile, such as read-only memory (ROM), flash memory, and the like. Furthermore, memory 1820 may include removable storage devices, such as secure digital (SD) cards. Memory 1820 may provide storage of computer-readable instructions, data structures, program code, and other data for electronic system 1800. In some embodiments, memory 1820 may be distributed into different hardware subsystems. A set of instructions and/or code might be stored on memory 1820. The instructions might take the form of executable code that may be executable by electronic system 1800, and/or might take the form of source and/or installable code, which, upon compilation and/or installation on electronic system 1800 (e.g., using any of a variety of generally available compilers, installation programs, compression/decompression utilities, etc.), may take the form of executable code.

In some embodiments, memory 1820 may store a plurality of applications 1822 through 1824, which may include any number of applications. Examples of applications may include gaming applications, conferencing applications, video playback applications, or other suitable applications. The applications may include a depth sensing function or eye tracking function. Applications 1822-1824 may include particular instructions to be executed by processor(s) 1810. In some embodiments, certain applications or parts of applications 1822-1824 may be executable by other hardware subsystems 1880. In certain embodiments, memory 1820 may additionally include secure memory, which may include additional security controls to prevent copying or other unauthorized access to secure information.

In some embodiments, memory 1820 may include an operating system 1825 loaded therein. Operating system 1825 may be operable to initiate the execution of the instructions provided by applications 1822-1824 and/or manage other hardware subsystems 1880 as well as interfaces with a wireless communication subsystem 1830 which may include one or more wireless transceivers. Operating system 1825 may be adapted to perform other operations across the components of electronic system 1800 including threading, resource management, data storage control and other similar functionality.

Wireless communication subsystem 1830 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1800 may include one or more antennas 1834 for wireless communication as part of wireless communication subsystem 1830 or as a separate component coupled to any portion of the system. Depending on desired functionality, wireless communication subsystem 1830 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1830 may permit data to be exchanged with a network, other computer systems, and/or any other devices described herein. Wireless communication subsystem 1830 may include a means for transmitting or receiving data, such as identifiers of HMD devices, position data, a geographic map, a heat map, photos, or videos, using antenna(s) 1834 and wireless link(s) 1832.

Embodiments of electronic system 1800 may also include one or more sensors 1890. Sensor(s) 1890 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 1890 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1800 may include a display 1860. Display 1860 may be a near-eye display, and may graphically present information, such as images, videos, and various instructions, from electronic system 1800 to a user. Such information may be derived from one or more applications 1822-1824, virtual reality engine 1826, one or more other hardware subsystems 1880, a combination thereof, or any other suitable means for resolving graphical content for the user (e.g., by operating system 1825). Display 1860 may use liquid crystal display (LCD) technology, light-emitting diode (LED) technology (including, for example, OLED, ILED, uLED, AMOLED, TOLED, etc.), light emitting polymer display (LPD) technology, or some other display technology.

Electronic system 1800 may include a user input/output interface 1870. User input/output interface 1870 may allow a user to send action requests to electronic system 1800. An action request may be a request to perform a particular action. For example, an action request may be to start or end an application or to perform a particular action within the application. User input/output interface 1870 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1800. In some embodiments, user input/output interface 1870 may provide haptic feedback to the user in accordance with instructions received from electronic system 1800. For example, the haptic feedback may be provided when an action request is received or has been performed.

Electronic system 1800 may include a camera 1850 that may be used to take photos or videos of a user, for example, for tracking the user's eye position. Camera 1850 may also be used to take photos or videos of the environment, for example, for VR, AR, or MR applications. Camera 1850 may include, for example, a complementary metal-oxide-semiconductor (CMOS) image sensor with a few millions or tens of millions of pixels. In some implementations, camera 1850 may include two or more cameras that may be used to capture 3-D images.

In some embodiments, electronic system 1800 may include a plurality of other hardware subsystems 1880. Each of other hardware subsystems 1880 may be a physical subsystem within electronic system 1800. While each of other hardware subsystems 1880 may be permanently configured as a structure, some of other hardware subsystems 1880 may be temporarily configured to perform specific functions or temporarily activated. Examples of other hardware subsystems 1880 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 1880 may be implemented in software.

In some embodiments, memory 1820 of electronic system 1800 may also store a virtual reality engine 1826. Virtual reality engine 1826 may execute applications within electronic system 1800 and receive position information, acceleration information, velocity information, predicted future positions, or some combination thereof of the HMD device from the various sensors. In some embodiments, the information received by virtual reality engine 1826 may be used for producing a signal (e.g., display instructions) to display 1860. For example, if the received information indicates that the user has looked to the left, virtual reality engine 1826 may generate content for the HMD device that mirrors the user's movement in a virtual environment. Additionally, virtual reality engine 1826 may perform an action within an application in response to an action request received from user input/output interface 1870 and provide feedback to the user. The provided feedback may be visual, audible, or haptic feedback. In some implementations, processor(s) 1810 may include one or more GPUs that may execute virtual reality engine 1826.

In various implementations, the above-described hardware and subsystems may be implemented on a single device or on multiple devices that can communicate with one another using wired or wireless connections. For example, in some implementations, some components or subsystems, such as GPUs, virtual reality engine 1826, and applications (e.g., tracking application), may be implemented on a console separate from the head-mounted display device. In some implementations, one console may be connected to or support more than one HMD.

In alternative configurations, different and/or additional components may be included in electronic system 1800. Similarly, functionality of one or more of the components can be distributed among the components in a manner different from the manner described above. For example, in some embodiments, electronic system 1800 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

In this description, the recitation “based on” means “based at least in part on.” Therefore, if X is based on Y, then X may be a function of at least a part of Y and any number of other factors. If an action X is “based on” Y, then the action X may be based at least in part on at least a part of Y.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components, or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A near-eye display comprising:
a display panel configured to display images; and
display optics configured to project the images to a user's eye,
wherein a peak luminance angle at each region of a plurality of regions of the display panel matches a respective chief ray angle of the region seen through the display optics.

2. The near-eye display of claim 1, wherein:
the display panel includes a liquid crystal display (LCD) panel that includes a black matrix formed on a first substrate and light shield structures formed on a second substrate; and
black matrix elements at each region of the plurality of regions are shifted with respect to corresponding light shield structures at the region by a respective amount such that the peak luminance angle at the region matches the respective chief ray angle of the region seen through the display optics.

3. The near-eye display of claim 2, wherein the amount of shift gradually increases from a center region of the display panel to peripheral regions of the display panel.

4. The near-eye display of claim 2, wherein the amount of shift gradually increases from a center region of the display panel to peripheral regions of the display panel along a horizontal direction, a vertical direction, both the horizontal direction and the vertical direction, or a radial direction.

5. The near-eye display of claim 2, wherein:
the LCD panel includes thin-film transistor circuits formed on the second substrate; and
the light shield structures include electrodes of the thin-film transistor circuits.

6. The near-eye display of claim 5, wherein the electrodes of the thin-film transistor circuits include:
a first plurality of electrodes uniformly positioned along a first direction; and
a second plurality of electrodes uniformly positioned along a second direction that is perpendicular to the first direction.

7. The near-eye display of claim 5, wherein the light shield structures include light shields above or below the electrodes of the thin-film transistor circuits, the light shields aligned with the electrodes of the thin-film transistor circuits.

8. The near-eye display of claim 2, wherein the black matrix elements include a first plurality of black matrix elements along a first direction, the first plurality of black matrix elements having a nonuniform pitch that gradually decreases and then gradually increases along the first direction.

9. The near-eye display of claim 8, wherein the black matrix elements further include a second plurality of black matrix elements along a second direction that is perpendicular to the first direction, the second plurality of black matrix elements having a nonuniform pitch along the second direction.

10. The near-eye display of claim 1, wherein the display optics include one or more lenses.

11. A display panel comprising:
a first assembly including a first substrate and light shield structures formed on the first substrate;
a second assembly including a second substrate and black matrix elements formed on the second substrate; and
a liquid crystal layer between the first assembly and the second assembly,
wherein:
black matrix elements at a center region of the display panel align with corresponding light shield structures on the first substrate; and
black matrix elements at peripheral regions of the display panel are offset with respect to corresponding light shield structures on the first substrate.

12. The display panel of claim 11, wherein an amount of offset of the black matrix elements with respect to the light shield structures gradually increases from the center region of the display panel to the peripheral regions of the display panel.

13. The display panel of claim 12, wherein the amount of offset gradually increases from the center region of the display panel to the peripheral regions of the display panel along a horizontal direction, a vertical direction, both the horizontal direction and the vertical direction, or radial direction.

14. The display panel of claim 11, wherein:
the first assembly includes thin-film transistor circuits formed on the first substrate; and
the light shield structures include electrodes of the thin-film transistor circuits, the electrodes of the thin-film transistor circuits including:
a first plurality of electrodes uniformly positioned along a first direction; and
a second plurality of electrodes uniformly positioned along a second direction perpendicular to the first direction.

15. The display panel of claim 11, wherein the black matrix elements include a first plurality of black matrix elements along a first direction, the first plurality of black matrix elements having a nonuniform pitch that gradually decreases and then gradually increases along the first direction.

16. The display panel of claim 15, wherein the black matrix elements further include a second plurality of black matrix elements along a second direction that is perpendicular to the first direction, the second plurality of black matrix elements having a nonuniform pitch along the second direction.

17. A method of improving brightness uniformity of a near-eye display, the method comprising, for each region of a plurality of regions of a liquid crystal display (LCD) panel of the near-eye display:
determining a chief ray angle of the region seen through display optics of the near-eye display;
determining an offset between black matrix elements on a first substrate of the LCD panel and light shield structures on a second substrate of the LCD panel at the region for achieving peak luminance at the chief ray angle of the region; and
shifting the black matrix elements with respect to the light shield structures at the region based on the determined offset.

18. The method of claim 17, wherein the light shield structures on the second substrate include gate electrodes of thin-film transistor circuits formed on the second substrate, source electrodes of the thin-film transistor circuits, top light shields, bottom light shields, or a combination thereof.

19. The method of claim 17, wherein the offset gradually increases from a center region of the LCD panel to peripheral regions of the LCD panel along a horizontal direction, a vertical direction, both the horizontal direction and the vertical direction, or a radial direction.

20. The method of claim 17, wherein:
the light shield structures include:
a first plurality of electrodes uniformly positioned along a first direction; and
a second plurality of electrodes uniformly positioned along a second direction that is perpendicular to the first direction; and
the black matrix elements include:
a first plurality of black matrix elements positioned along the first direction, the first plurality of black matrix elements having a nonuniform pitch along the first direction; and
a second plurality of black matrix elements positioned along the second direction, the second plurality of black matrix elements having a nonuniform pitch along the second direction.
